(19) United States
(12) Patent Application Publication
(10) Pub. No.: US 2018/0196377 A1
(43) Pub. Date: Jul. 12, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventors: Ken IGUCHI, Numazu Shizuoka (JP); Eiji SHINOHARA, Mishima Shizuoka (JP)

(21) Appl. No.: 15/642,187

(22) Filed: Jul. 5, 2017

(30) Foreign Application Priority Data
Jan. 6, 2017 (JP) 2017-000996

(51) Int. Cl. G03G 15/20

(52) U.S. Cl. CPC G03G 15/205; G03G 15/2007

(57) ABSTRACT

An image forming apparatus includes a heat roller, a lamp, and a control unit. The heat roller fixes a toner image transferred onto a sheet. The lamp heats the heat roller. The control unit controls switching of the lamp on and off according to one of a first duty control and a second duty control that the control unit selects based on a mode of operation of the image forming apparatus.

### CROSS-REFERENCE TO RELATED APPLICATION

This application is based upon and claims the benefit of priority from Japanese Patent Application No. 2017-000996, filed Jan. 6, 2017, the entire contents of which are incorporated herein by reference.

### FIELD

Embodiments described herein relate generally to an image forming apparatus.

### BACKGROUND

In fixing processing, duty control according to which turning-on and turning-off of a heat lamp are alternately repeated with a certain period so as to prevent or reduce ripple, which is an increase or decrease in temperature relative to a target temperature, is known. However, in such duty control, since the switching frequency of the heat lamp between turning-on and turning-off is increased compared to a case where the above duty control is not applied, the lifetime of the heat lamp may be shortened.

### DESCRIPTION OF THE DRAWINGS

FIG. 1 is a diagram illustrating an entire configuration example of an image forming apparatus according to an embodiment.

FIG. 2 is a diagram illustrating an example of a fixing unit.

FIG. 3 is a schematic block diagram illustrating a configuration of functional blocks of the image forming apparatus.

FIG. 4 is a diagram illustrating a specific example of a control table.

FIG. 5 is a flowchart illustrating the flow of processing performed by the image forming apparatus according to the embodiment.

FIG. 6 is a diagram illustrating an example of first duty control.

FIG. 7 is a diagram illustrating processing for second duty control according to the embodiment.

FIG. 8 is a diagram illustrating processing for second duty control according to a modification example.

### DETAILED DESCRIPTION

Embodiments provide an image forming apparatus capable of improving the lifetime of a heat lamp.

In general, according to one embodiment, an image forming apparatus includes a heat roller, a lamp, and a control unit. The heat roller fixes a toner image transferred onto a sheet. The lamp heats the heat roller. The control unit controls switching of the lamp on and off according to one of a first duty control and a second duty control that the control unit selects based on a mode of operation of the image forming apparatus.

[Outline]

An image forming apparatus according to an embodiment is capable of improving the lifetime of a heat lamp. Hereinafter, the image forming apparatus according to the embodiment will be described in detail.

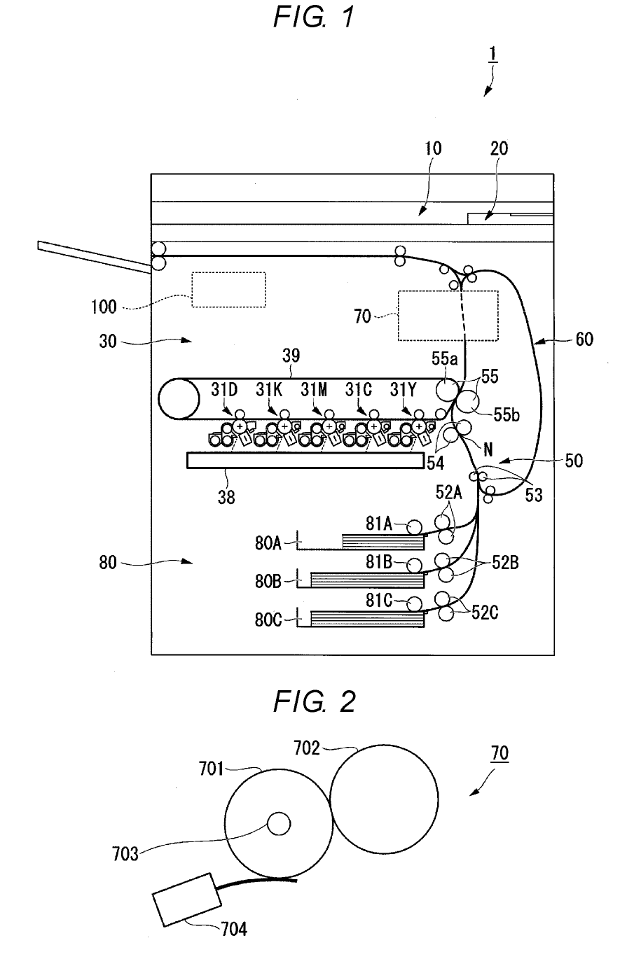

FIG. 1 is a diagram illustrating an entire configuration example of an image forming apparatus 1 according to an embodiment.

The image forming apparatus 1 according to the embodiment is a multifunction peripheral (MFP). The image forming apparatus 1 performs image forming processing and decoloring processing. The image forming processing is a processing for forming an image on a sheet. The sheet, which is subjected to the image forming process, may be a sheet of paper or a label sheet, or the like. Furthermore, the sheet may be of any form as long as an image can be formed thereon by the image forming apparatus 1. The decoloring processing is a processing for decoloring an image formed on the sheet. The sheet, which is subjected to the decoloring process, may be a sheet of paper with a text, image, or the like formed thereon with decolorable recording agent described later. Decoloring as used in the present embodiment refers to making an image formed with a color or colors (including not only chromatic colors but also achromatic colors, such as white and black) different from the base color of a sheet visually invisible. Furthermore, decoloring can be performed by a method other than by heating. The image forming apparatus 1 reads an image formed on the sheet to generate digital data, thus generating an image file. The sheet, which is subjected to the image reading process, may be an original document, a sheet of paper, or the like.

The image forming apparatus 1 includes an image reading unit 10, a control panel 20, a printer unit 30, a sheet container unit 80, and a control unit 100. Furthermore, the printer unit 30 of the image forming apparatus 1 can be a device that fixes a toner image onto the sheet or can be an inkjet-type device. In the present embodiment, a case where the printer unit 30 is a device that fixes a toner image onto the sheet is described as an example.

The image reading unit 10 reads image information targeted for reading as the brightness of light. The image reading unit 10 stores the read image information. The stored image information can be transmitted to an external information processing apparatus via a network. The stored image information can be used to form an image on a sheet by the printer unit 30.

The control panel 20 includes a display unit and an operation unit. The display unit is a display device, such as a liquid crystal display or an organic electroluminescence (EL) display. The display unit displays various pieces of information about the image forming apparatus 1. The operation unit includes, for example, a plurality of buttons. The operation unit receives an operation performed by the user. The operation unit outputs a signal generated according to an operation performed by the user to the control unit 100 of the image forming apparatus 1. Furthermore, the display unit and the operation unit can be integrally configured as a touch panel display.

The printer unit 30 performs image forming processing and decoloring processing. In the image forming processing, the printer unit 30 forms an image on a sheet based on image information generated by the image reading unit 10 or image information received via a communication path. Furthermore, the printer unit 30 in the present embodiment uses toner serving as a decolorable (erasable) recording agent (hereinafter referred to as “decoloring toner”) and toner serving as a non-decolorable (non-erasable) recording agent (hereinafter referred to as “ordinary toner”). The ordinary toner is, for example, toner of yellow (Y), magenta (M), cyan (C), or black (K). The decoloring toner is colored toner as with the ordinary toner, and is, for example, toner of black. The decoloring toner is decolored at a temperature higher than the temperature at which the ordinary toner is fixed onto a sheet. The printer unit 30 performs one of image forming processing using the decoloring toner, image forming processing using the ordinary toner, and decoloring processing under the control of the control unit 100. In the following description, image forming processing using the decoloring toner is referred to as decoloring printing, and image forming processing using the ordinary toner is referred to as ordinary printing.

The sheet container unit 80 includes a plurality of paper feed cassettes 80A, 80B, and 80C. The paper feed cassettes 80A, 80B, and 80C contain sheets of respective predetermined sizes and types. The paper feed cassettes 80A, 80B, and 80C are provided with pickup rollers 81A, 81B, and 81C, respectively. The pickup rollers 81A, 81B, and 81C extract sheets on a sheet-by-sheet basis from the paper feed cassettes 80A, 80B, and 80C, respectively. The pickup rollers 81A, 81B, and 81C each supplies the extracted sheet to a conveyance unit 50.

The conveyance unit 50 conveys sheets in the printer unit 30 and the sheet container unit 80. The conveyance unit 50 includes paper feed rollers 52A, paper feed rollers 52B, paper feed rollers 52C, conveyance rollers 53, and registration rollers 54. The paper feed rollers 52A, paper feed rollers 52B, and paper feed rollers 52C convey sheets respectively fed by the pickup rollers 81A, 81B, and 81C to the registration rollers 54. The registration rollers 54 convey a sheet toward a transfer unit 55 of the printer unit 30, which is described below, according to timing at which the transfer unit 55 transfers a toner image onto the surface of the sheet. The registration rollers 54 align the front end of a sheet conveyed by the conveyance rollers 53 at a nip N and, then, convey the sheet toward the transfer unit 55.

The control unit 100 controls each functional unit of the image forming apparatus 1. Specific details of the control unit 100 are described below.

Next, a detailed configuration of the printer unit 30 will be described. The printer unit 30 includes a developing unit 31, an exposure unit 38, an intermediate transfer belt 39, the transfer unit 55, a reversal unit 60, and a fixing unit or device 70. In the present embodiment, the developing unit 31 has a predetermined number of types of toner. Hereinafter, a developing unit corresponding to toner of yellow (Y) is referred to as a “developing unit 31Y”, and a developing unit corresponding to toner of magenta (M) is referred to as a “developing unit 31M”. Moreover, a developing unit corresponding to toner of cyan (C) is referred to as a “developing unit 31C”, and a developing unit corresponding to toner of black (K) is referred to as a “developing unit 31K”. Additionally, a developing unit corresponding to the decoloring toner is referred to as a “developing unit 31D”.

Each of the developing units 31 (31Y, 31M, 31C, 31K, and 31D) supplies developer contained in a developer container unit thereof to corresponding photosensitive drum. The developer container unit is a container in which a developer is contained. The developer is a mixture of carrier, which includes magnetic microparticles, and each piece of toner. As the developer is agitated, toner is frictionally electrified. With this, toner electrically adheres to the surface of carrier due to electrostatic force. A first mixer, a second mixer, a developing roller, and a temperature and humidity sensor are arranged inside the developer container unit. The first mixer and the second mixer agitate a developer. The first mixer and the second mixer convey the developer. The second mixer is located below the developing roller. The second mixer supplies a developer contained in the developer container unit to the surface of the developing roller. The temperature and humidity sensor detects the temperature and humidity of the inside of the developer container unit as a status of the printer unit 30.

The developing roller rotates counterclockwise according to driving of a developing motor. The developing roller is configured with a magnetic body (magnet) in which positive poles and negative poles are alternately arranged side by side along the circumferential surface of the developing roller. The developer supplied by the second mixer stands up in a brush shape on the surface of the developing roller according to the magnetic field distribution of the developing roller. The rising developer in the brush shape contacts the surface of the photosensitive drum in such a way as to sweep that surface in association with the rotation of the developing roller. Furthermore, the magnetic field distribution of the developing roller is switchable. The developing unit 31 causes the developer to rise and to be lowered according to switching of the magnetic field distribution of the developing roller. The developing roller is connected to a voltage applying circuit. The voltage applying circuit applies a voltage as a developing bias to the developing roller under the control of the control unit 100. The voltage to be applied to the developing roller is, for example, a direct-current voltage of negative polarity.

The photosensitive drum has a photosensitive layer on the circumferential surface thereof. The photosensitive drum rotates clockwise according to driving of the developing motor. The developing unit 31, a charging unit, a discharging unit, a cleaning unit, and a transfer roller are arranged around the photosensitive drum.

The charging unit uniformly charges the circumferential surface (photosensitive layer) of the photosensitive drum. For example, the charging unit charges the circumferential surface (photosensitive layer) of the photosensitive drum to a negative polarity. With this, a toner image is formed on the circumferential surface (photosensitive layer) of the photosensitive drum according to an electrostatic latent image.

For example, the developing unit 31Y develops an electrostatic latent image on the circumferential surface (photosensitive layer) of the photosensitive drum with toner of yellow (Y). Moreover, the developing unit 31M develops an electrostatic latent image on the circumferential surface (photosensitive layer) of the photosensitive drum with toner of magenta (M). Moreover, the developing unit 31C develops an electrostatic latent image on the circumferential surface (photosensitive layer) of the photosensitive drum with toner of cyan (C). Moreover, the developing unit 31K develops an electrostatic latent image on the circumferential surface (photosensitive layer) of the photosensitive drum with toner of black (K). Moreover, the developing unit 31D develops an electrostatic latent image on the circumferential surface (photosensitive layer) of the photosensitive drum with decolorable toner.

The cleaning unit removes, for example, by scraping, untransferred toner on the circumferential surface of the photosensitive drum. After the toner image is transferred from the photosensitive drum onto the intermediate transfer belt 39, the cleaning unit removes toner remaining on the circumferential surface of the photosensitive drum. The toner removed by the cleaning unit is collected into a waste toner tank and is thus disposed of.

The discharging unit faces the photosensitive drum passing over the cleaning unit. The discharging unit irradiates the circumferential surface of the photosensitive drum with light. With this, the uneven charge of the photosensitive layer is homogenized. In other words, the electric charges on the photosensitive layer are discharged.

The transfer roller faces the photosensitive drum across the intermediate transfer belt 39. The transfer roller contacts the surface of the photosensitive drum across the intermediate transfer belt 39. The transfer roller transfers (primarily transfers) a toner image formed on the surface of the photosensitive drum onto the intermediate transfer belt 39.

The exposure unit 38 is located at a position facing the circumferential surfaces of the photosensitive drums of the respective developing units 31Y, 31M, 31C, 31K, and 31D. The exposure unit 38 irradiates the surfaces (photosensitive layers) of the photosensitive drums of the respective developing units 31Y, 31M, 31C, 31K, and 31D with laser light. The light emitting operation of the exposure unit 38 is controlled by the control unit 100 based on image data. The exposure unit 38 emits laser light that is based on image data. With this, negative charges on the circumferential surfaces (photosensitive layers) of the photosensitive drums of the respective developing units 31Y, 31M, 31C, 31K, and 31D disappear. As a result, an electrostatic pattern is formed at a position irradiated with laser light on the circumferential surface (photosensitive layer) of the photosensitive drum. In other words, an electrostatic latent image is formed on the circumferential surface (photosensitive layer) of the photosensitive drum according to irradiation with laser light performed by the exposure unit 38. Furthermore, the exposure unit 38 can use light-emitting diode (LED) light instead of laser light.

The reversal unit 60 reverses, by switchback, a sheet discharged from the fixing unit 70. The reversal unit 60 re-conveys the reversed sheet to the front side of the registration roller 54. The reversal unit 60 reverses a sheet once subjected to fixing processing so as to forma toner image on the reverse surface of the sheet.

The fixing unit 70 applies heat and pressure to a sheet. The fixing unit 70 uses the heat and pressure to fix a toner image transferred onto the sheet.

FIG. 2 is a diagram illustrating an example of the fixing unit 70. The fixing unit 70 includes a heat roller 701, a press roller 702, a heat lamp 703, and a thermistor 704. The heat roller 701 is warmed by heat generated by the heat lamp 703 turning on. The heat roller 701 applies heat to a sheet. The press roller 702 is located opposite the heat roller 701. The press roller 702 presses a sheet against the heat roller 701. The heat lamp 703 switches between turning-on and turning-off under the control of the control unit 100. The heat lamp 703 is, for example, a halogen lamp. The thermistor 704 detects the surface temperature of the heat roller 701. The thermistor 704 outputs information about the detected surface temperature of the heat roller 701 to the control unit 100.

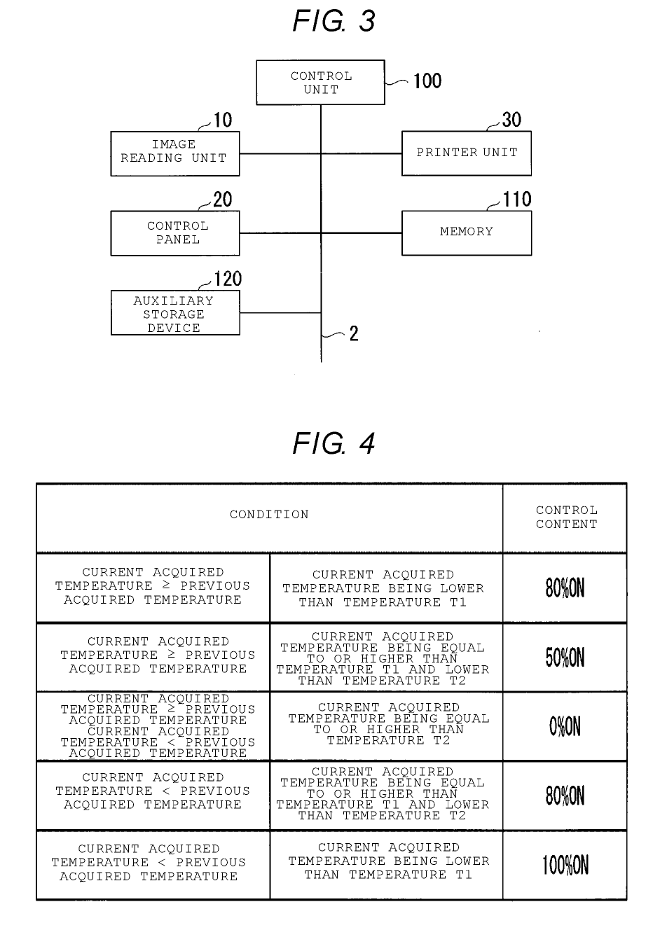

FIG. 3 is a schematic block diagram illustrating a configuration of functional blocks of the image forming apparatus 1.

The explanation of the image reading unit 10, the control panel 20, and the printer unit 30 illustrated in FIG. 3 is similar to the above description and is, therefore, not repeated. Hereinafter, the control unit 100, a memory 110, and an auxiliary storage device 120 are described. Furthermore, the above functional units are interconnected via a system bus 2 in such a way as to be able to perform data communication.

The control unit 100 controls turning-on and turning-off of the heat lamp 703 according to an instruction for image forming processing issued to the image forming apparatus 1. For example, the control unit 100 performs first duty control and second duty control. The first duty control is a control operation which switches between turning-on and turning-off of the heat lamp 703 with a predetermined period. For example, the first duty control is a control operation which controls the heat lamp 703 to switch between turning-on state and turning-off state depending on whether the surface temperature of the heat roller 701 exceeds a target temperature. The second duty control is a control operation which controls the heat lamp 703 to switch between turning-on and turning-off with a period smaller than the predetermined period in the first duty control. Furthermore, the second duty control is a control operation which switches between turning-on and turning-off while changing the rate of a turning-on period of time of the heat lamp 703 based on the surface temperature of the heat roller 701. The control unit 100 acquires information about the surface temperature of the heat roller 701 at a predetermined interval (for example, at intervals of 100 ms) from the thermistor 704.

The memory 110 is, for example, a random access memory (RAM). The memory 110 temporarily stores data to be used by various functional units included in the image forming apparatus 1. Furthermore, the memory 110 may store digital data generated by the image reading unit 10. The memory 110 may temporarily store a job data and a job log.

The auxiliary storage device 120, which is, for example, a hard disk or a solid state drive (SSD), stores various pieces of data. The various pieces of data may include, for example, a control table, digital data, a job data, and a job log. The control table is a table in which information about the second duty control is registered.

FIG. 4 is a diagram illustrating a specific example of the control table. The control table has a plurality of registered information indicating information about the second duty control. Each registered information has the values of a condition and control content. The value of the condition indicates a condition on which to perform the second duty control. The value of the control content indicates the content of control that is performed when the condition is satisfied.

In the example illustrated in FIG. 4, a plurality of conditions are registered in the control table. In FIG. 4, an information registered on the first line of the control table indicates that the value of the condition is “current acquired temperature≥previous acquired temperature” and “current acquired temperature being lower than temperature T1” and the value of the control content is “80% ON”. This represents that in a case where the current acquired temperature is equal to or higher than the previous acquired temperature and the current acquired temperature is lower than the temperature T1, control is performed to set the turning-on period of the heat lamp 703 to 80% and set the turning-off period thereof to 20%. The turning-on period and the turning-off period refer to control periods of time for turning-on and turning-off of the heat lamp 703 during one cycle. The current acquired temperature refers to the latest temperature acquired from the thermistor 704. The previous acquired temperature refers to the temperature acquired immediately before the current acquired temperature.

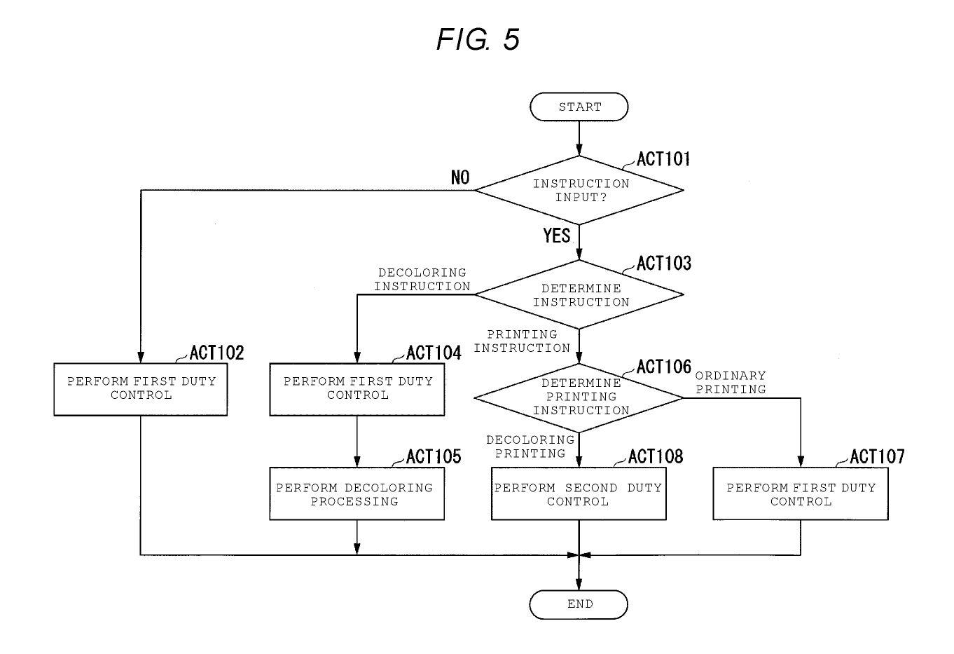

FIG. 5 is a flowchart illustrating the flow of processing performed by the image forming apparatus 1 according to the present embodiment. In the processing illustrated in FIG. 5, the control unit 100 is supposed to acquire temperature information from the thermistor 704 at a predetermined interval.

In step ACT101, the control unit 100 determines whether an instruction is input on the control panel 20. If no instruction is input (NO in step ACT101), then in step ACT102, the control unit 100 performs the first duty control. A case where no instruction is input, as used herein, refers to a case where no job is input, and indicates, for example, the time of waiting (for example, the time of warming-up or the time of ready). In a case where no instruction is input, no sheet passes through the fixing unit 70. In this way, in a case where no sheet passes through the fixing unit 70, the control unit 100 performs the first duty control.

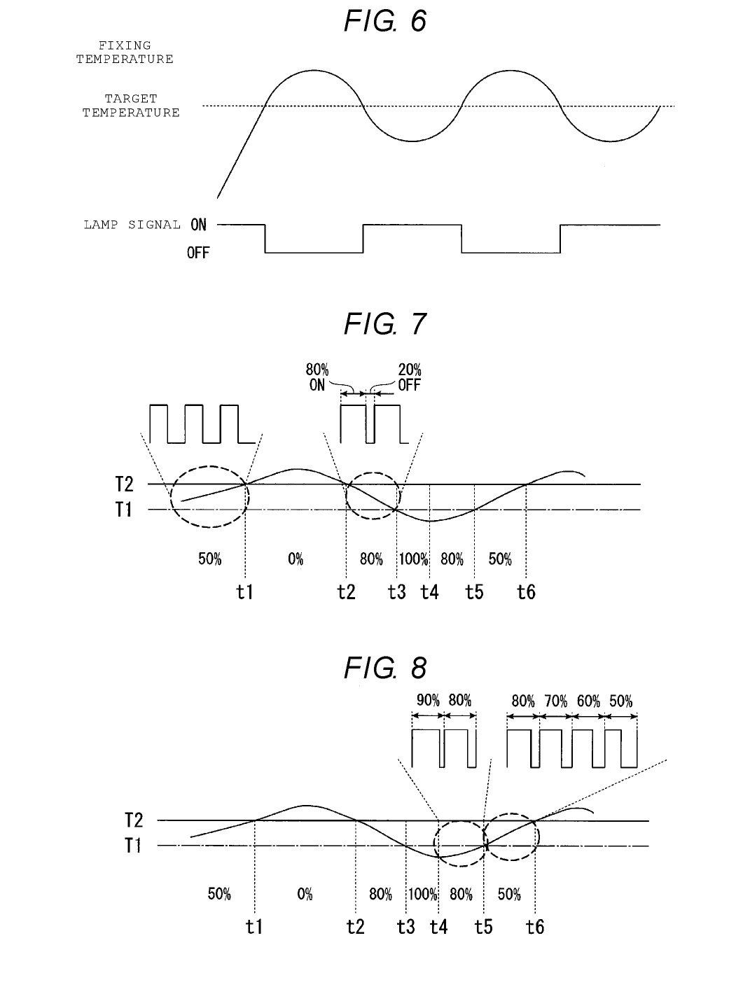

FIG. 6 illustrates an example of the first duty control. As illustrated in FIG. 6, in a case where the temperature of the heat roller 701 exceeds the target temperature, the control unit 100 turns off the heat lamp 703 (OFF in LAMP SIGNAL). Furthermore, as illustrated in FIG. 6, in a case where the temperature of the heat roller 701 falls below the target temperature, the control unit 100 turns on the heat lamp 703 (ON in LAMP SIGNAL). The control unit 100 performs the first duty control by repeating such control. Then, the image forming apparatus 1 ends the processing illustrated in FIG. 5.

On the other hand, if an instruction is input (YES in step ACT101), then in step ACT103, the control unit 100 determines whether the input instruction is a printing instruction or a decoloring instruction. If the input instruction is a decoloring instruction (DECOLORING INSTRUCTION in step ACT103), then in step ACT104, the control unit 100 performs the first duty control. Then, in step ACT105, the printer unit 30 performs decoloring processing. More specifically, with respect to a sheet discharged from the sheet container unit 80, the printer unit 30 applies a temperature higher than the temperature used at the time of decoloring printing to the sheet, thus decoloring an image on the sheet. Then, the processing illustrated in FIG. 5 ends.

On the other hand, if the input instruction is a printing instruction (PRINTING INSTRUCTION in step ACT103), then in step ACT106, the control unit 100 determines whether the input printing instruction is an instruction for decoloring printing or an instruction for ordinary printing. If the input printing instruction is an instruction for ordinary printing (ORDINARY PRINTING in step ACT106), then in step ACT107, the control unit 100 performs the first duty control.

If the input printing instruction is an instruction for decoloring printing (DECOLORING PRINTING in step ACT106), then in step ACT108, the control unit 100 performs the second duty control. In the present embodiment, the control unit 100 performs turning-on and turning-off of the heat lamp 703 at timing of zero-crossing of an AC voltage so as to suppress an inrush current to the minimum.

Here, the second duty control is described. The control unit 100 performs the following control based on the control table and information about the surface temperature of the heat roller 701. In a case where the current acquired temperature is equal to or higher than the previous acquired temperature and the current acquired temperature is lower than the temperature T1, the control unit 100 performs control to set the turning-on period of the heat lamp 703 to 80% and set the turning-off period thereof to 20%. In a case where the current acquired temperature is equal to or higher than the previous acquired temperature and the current acquired temperature is equal to or higher than the temperature T1 and lower than the temperature T2, the control unit 100 performs control to set the turning-on period of the heat lamp 703 to 50% and set the turning-off period thereof to 50%. In a case where the current acquired temperature is equal to or higher than the previous acquired temperature and the current acquired temperature is equal to or higher than the temperature T2, the control unit 100 performs control to set the turning-on period of the heat lamp 703 to 0% and set the turning-off period thereof to 100%. In a case where the current acquired temperature is lower than the previous acquired temperature and the current acquired temperature is equal to or higher than the temperature T2, the control unit 100 performs control to set the turning-on period of the heat lamp 703 to 0% and set the turning-off period thereof to 100%. In a case where the current acquired temperature is lower than the previous acquired temperature and the current acquired temperature is equal to or higher than the temperature T1 and lower than the temperature T2, the control unit 100 performs control to set the turning-on period of the heat lamp 703 to 80% and set the turning-off period thereof to 20%. In a case where the current acquired temperature is lower than the previous acquired temperature and the current acquired temperature is lower than the temperature T1, the control unit 100 performs control to set the turning-on period of the heat lamp 703 to 100% and set the turning-off period thereof to 0%.

A result obtained by performing control on the above-described conditions is illustrated in FIG. 7. FIG. 7 is a diagram illustrating processing for the second duty control in the present embodiment. As illustrated in FIG. 7, during a period from the start time of processing to time t1, the temperature is increasing and is equal to or higher than the temperature T1 and lower than the temperature T2. When information about the surface temperature is acquired during this period, the control unit 100 first refers to the control table and selects registered information satisfying the applicable condition from the control table. In this case, the control unit 100 selects registered information in which the condition indicates “current acquired temperature previous acquired temperature” and “current acquired temperature being equal to or higher than temperature T1 and lower than temperature T2”. Next, the control unit 100 acquires a value registered in the item of the control content of the selected registered information. In this case, the control unit 100 acquires a value of “50% ON” as the control content. Then, the control unit 100 performs control to set the turning-on period of the heat lamp 703 to 50% and set the turning-off period thereof to 50% at timing of zero-crossing based on the acquired value.

Next, during a period from time t1 to time t2, the temperature is increasing and then decreasing and is equal to or higher than the temperature T2. When information about the surface temperature is acquired during this period, the control unit 100 first refers to the control table and selects registered information satisfying the applicable condition from the control table. For example, in a case where the current acquired temperature is equal to or higher than the previous acquired temperature, the control unit 100 selects registered information in which the condition indicates “current acquired temperature≥previous acquired temperature” and “current acquired temperature being equal to or higher than temperature T2”. Next, the control unit 100 acquires a value registered in the item of the control content of the selected registered information. In this case, the control unit 100 acquires a value of “0% ON” as the control content. Then, the control unit 100 performs control to set the turning-on period of the heat lamp 703 to 0% and set the turning-off period thereof to 100% at timing of zero-crossing based on the acquired value.

Moreover, for example, in a case where the current acquired temperature is lower than the previous acquired temperature, the control unit 100 selects registered information in which the condition indicates “current acquired temperature<previous acquired temperature” and “current acquired temperature being equal to or higher than temperature T2”. Next, the control unit 100 acquires a value registered in the item of the control content of the selected registered information. In this case, the control unit 100 acquires a value of “0% ON” as the control content. Then, the control unit 100 performs control to set the turning-on period of the heat lamp 703 to 0% and set the turning-off period thereof to 100% at timing of zero-crossing based on the acquired value.

Next, during a period from time t2 to time t3, the temperature is decreasing and is equal to or higher than the temperature T1 and lower than the temperature T2. When information about the surface temperature is acquired during this period, the control unit 100 first refers to the control table and selects registered information satisfying the applicable condition from the control table. In this case, the control unit 100 selects registered information in which the condition indicates “current acquired temperature<previous acquired temperature” and “current acquired temperature being equal to or higher than temperature T1 and lower than temperature T2”. Next, the control unit 100 acquires a value registered in the item of the control content of the selected registered information. In this case, the control unit 100 acquires a value of “80% ON” as the control content. Then, the control unit 100 performs control to set the turning-on period of the heat lamp 703 to 80% and set the turning-off period thereof to 20% at timing of zero-crossing based on the acquired value.

Next, during a period from time t3 to time t4, the temperature is decreasing and is lower than the temperature T1. When information about the surface temperature is acquired during this period, the control unit 100 first refers to the control table and selects registered information satisfying the applicable condition from the control table. In this case, the control unit 100 selects registered information in which the condition indicates “current acquired temperature<previous acquired temperature” and “current acquired temperature being lower than temperature T1”. Next, the control unit 100 acquires a value registered in the item of the control content of the selected registered information. In this case, the control unit 100 acquires a value of “100% ON” as the control content. Then, the control unit 100 performs control to set the turning-on period of the heat lamp 703 to 100% and set the turning-off period thereof to 0% at timing of zero-crossing based on the acquired value.

Next, during a period from time t4 to time t5, the temperature is increasing and is lower than the temperature T1. When information about the surface temperature is acquired during this period, the control unit 100 first refers to the control table and selects registered information satisfying the applicable condition from the control table. In this case, the control unit 100 selects registered information in which the condition indicates “current acquired temperature previous acquired temperature” and “current acquired temperature being lower than temperature T1”. Next, the control unit 100 acquires a value registered in the item of the control content of the selected registered information. In this case, the control unit 100 acquires a value of “80% ON” as the control content. Then, the control unit 100 performs control to set the turning-on period of the heat lamp 703 to 80% and set the turning-off period thereof to 20% at timing of zero-crossing based on the acquired value.

Next, during a period from time t5 to time t6, the temperature is increasing and is equal to or higher than the temperature T1 and lower than the temperature T2. When information about the surface temperature is acquired during this period, the control unit 100 first refers to the control table and selects registered information satisfying the applicable condition from the control table. In this case, the control unit 100 selects registered information in which the condition indicates “current acquired temperature previous acquired temperature” and “current acquired temperature being equal to or higher than temperature T1 and lower than temperature T2”. Next, the control unit 100 acquires a value registered in the item of the control content of the selected registered information. In this case, the control unit 100 acquires a value of “50% ON” as the control content. Then, the control unit 100 performs control to set the turning-on period of the heat lamp 703 to 50% and set the turning-off period thereof to 50% at timing of zero-crossing based on the acquired value.

The image forming apparatus 1 configured as described above is capable of reducing an influence on the lifetime of a heat lamp. More specifically, in the ordinary printing and the decoloring operation, since a heat equal to or greater than a predetermined amount is applied and there is a certain degree of width with respect to the upper limit temperature, processing can be performed in a normal way even if ripple is somewhat large. On the other hand, in the decoloring printing, if a heat equal to or higher than the decoloring temperature is applied during printing, an image formed on the sheet with the decolorable toner is decolored simultaneously with the printing, so that normal printing processing cannot be performed. Therefore, the width to the upper limit temperature is small and the conditions for temperature control are strict. To address this issue, the image forming apparatus 1 in the present embodiment performs the second duty control only in the case of the decoloring printing. With this, the second duty control is not performed at the time of waiting (for example, the time of warming-up or the time of ready) or at the time of normal printing. Therefore, an influence on the lifetime of a heat lamp can be reduced.

Furthermore, the image forming apparatus 1 changes the duty ratio of turning-on and turning-off of the heat lamp 703 according to the surface temperature of the heat roller 701. In this way, the image forming apparatus 1 does not perform control over turning-on and turning-off according to whether the target temperature is exceeded, but performs control over turning-on and turning-off according to a change of the surface temperature acquired at a predetermined interval. With this, the width of deviation of the temperature with respect to the target temperature becomes small. Therefore, ripple, which is an increase or decrease in temperature with respect to the target temperature, can be prevented or reduced.

Hereinafter, a modification example of the image forming apparatus 1 is described.

The configuration of the fixing unit 70 does not need to be limited to the configuration illustrated in FIG. 2. For example, the heat roller 701 can include a plurality of heat pumps, or both the heat roller 701 and the press roller 702 can include heat pumps.

While, in the present embodiment, a configuration using only information about the surface temperature of the heat roller 701 as the conditions registered in the control table is described, this is not limiting. For example, the conditions registered in the control table can include any one of the sheet conveyance speed, the sheet thickness, and the temperature around the image forming apparatus 1. With this configuration, not only the surface temperature of the heat roller 701 but also various conditions can be used to control the heat lamp 703.

In the present embodiment, a configuration in which the control unit 100 controls turning-on and turning-off of the heat lamp 703 at the rate indicated by the value acquired from the control table at timing of zero-crossing is described. On the other hand, the control unit 100 can be configured to set the value acquired from the control table as a target value and gradually increase or decrease the duty toward the target value. For example, the control unit 100 gradually varies the duty in such a manner that the turning-on period changes from 0% to 10%, . . . , then, to 50% or from 100% to 90%, then, to 80% so as to reach the target value. The rate at which to vary the duty can be previously set. An example of this control is illustrated in FIG. 8.

FIG. 8 is a diagram illustrating processing for the second duty control in the modification example. According to the control table, during a period from time t4 to time t5, the control unit 100 acquires a value of “80% ON” as the control content. In the second duty control in the modification example, the acquired value serves as a target value. The control unit 100 performs control in such a manner that the duty of the turning-on period and turning-off period of the heat lamp 703 approaches the target value at each timing of zero-crossing based on the acquired value. In the example illustrated in FIG. 8, during a period from time t3 to time t4, the control unit 100 performs control to set the turning-on period of the heat lamp 703 to 100% and set the turning-off period thereof to 0%. During a period from time t4 to time t5, the control unit 100 controls turning-on and turning-off of the heat lamp 703 in such a manner that the value changes from “100% ON” to “90% ON”, then, to “80% ON” to reach the target value. Furthermore, when the target value is reached, the control unit 100 controls turning-on and turning-off of the heat lamp 703 at the rate indicated by the target value until the target value is changed.

With this configuration, ripple can be more prevented or reduced.

The image forming apparatus 1 according to at least one of the above-described embodiments includes a heat roller 701, a heat lamp 703, and a control unit 100. The heat roller 701 fixes a toner image transferred onto a sheet. The heat lamp 703 heats the heat roller 701. The control unit 100 performs first duty control and second duty control. With this, an influence on the lifetime of a heat lamp can be reduced.

The function of the image forming apparatus 1 in the above-described embodiment can be implemented by a computer. In that case, the function can be implemented by recording a program for implementing the function on a computer-readable recording medium, reading the program recorded on the recording medium into a computer system, and executing the program. Furthermore, the “computer system” as used herein includes an operating system (OS) and hardware such as peripheral equipment. Moreover, the “computer-readable recording medium” refers to a portable medium, such as a flexible disk, a magneto optical disk, a read-only memory (ROM), or a CD-ROM, or a storage device such as a hard disk incorporated in the computer system. Additionally, the “computer-readable recording medium” can include a matter which dynamically retains a program for a short period, such as a communication wire used to transmit a program via a network such as the Internet or a communication line such as a telephone line, and a matter which retains a program for a predetermined time, such as a volatile memory incorporated in a computer system serving as a server or a client in that case. Furthermore, the above-mentioned program can be the one which implements a part of the above-described function or can be the one which implements the above-described function in combination with a program previously recorded in the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a heat roller configured to fix a toner image transferred onto a sheet;
a lamp configured to heat the heat roller; and
a control unit configured to control switching of the lamp on an off according to one of a first duty control and a second duty control that the control unit selects based on a mode of operation of the image forming apparatus.

2. The image forming apparatus according to claim 1, wherein the control unit selects the first duty control during an idle time of the image forming apparatus.

3. The image forming apparatus according to claim 1, wherein the control unit selects the first duty control during a decoloring operation carried out by the image forming apparatus.

4. The image forming apparatus according to claim 1, wherein the control unit selects the first duty control during a non-decolorable image forming operation carried out by the image forming apparatus.

5. The image forming apparatus according to claim 1, wherein the control unit selects the second duty control during a decolorable image forming operation carried out by the image forming apparatus.

6. The image forming apparatus according to claim 1, wherein
according to the first duty control, the lamp is switched on and off based only on a temperature of the heat roller relative to a target temperature, and
according to the second duty control, the lamp is switched on and off based on the temperature of the heat roller relative to the target temperature, a reference temperature that is below the target temperature, and whether or not the temperature of the heat roller is increasing or decreasing.

7. The image forming apparatus according to claim 6, wherein
according to the second duty control, the lamp is controlled to be on with a first duty cycle when the temperature of the heat roller is less than the target temperature and greater than the reference temperature, a second duty cycle greater than the first duty cycle when the temperature of the heat roller is less than the reference temperature and the temperature of the heat roller is increasing, and a third duty cycle greater than the second duty cycle when the temperature of the heat roller is less than the reference temperature and the temperature of the heat roller is decreasing.

8. The image forming apparatus according to claim 6, wherein the first duty cycle is 50% and the third duty cycle is 100%.

9. An image forming apparatus comprising:
a fixing device configured to fix a toner image transferred onto a sheet, the fixing device including a lamp configured to raise a fixing temperature of the fixing device and a temperature detector configured to detect the fixing temperature; and
a control unit configured to control switching of the lamp on an off based on a mode of operation of the image forming apparatus and the fixing temperature detected by the temperature detector.

10. The image forming apparatus according to claim 9, wherein
during an idle time of the image forming apparatus, the lamp is switched on and off based only on a temperature of the heat roller relative to a target temperature.

11. The image forming apparatus according to claim 9, wherein
during a decoloring operation carried out by the image forming apparatus, the lamp is switched on and off based only on a temperature of the heat roller relative to a target temperature.

12. The image forming apparatus according to claim 9, wherein
during a non-decolorable image forming operation carried out by the image forming apparatus, the lamp is switched on and off based only on a temperature of the heat roller relative to a target temperature.

13. The image forming apparatus according to claim 9, wherein the control unit selects the second duty control
during a decolorable image forming operation carried out by the image forming apparatus, the lamp is switched on and off based on the temperature of the heat roller relative to the target temperature, a reference temperature that is below the target temperature, and whether or not the temperature of the heat roller is increasing or decreasing.

14. The image forming apparatus according to claim 13, wherein
during the decoloarable image forming operation carried out by the image forming apparatus, the lamp is controlled to be on with a first duty cycle when the temperature of the heat roller is less than the target temperature and greater than the reference temperature, a second duty cycle greater than the first duty cycle when the temperature of the heat roller is less than the reference temperature and the temperature of the heat roller is increasing, and a third duty cycle greater than the second duty cycle when the temperature of the heat roller is less than the reference temperature and the temperature of the heat roller is decreasing.

15. The image forming apparatus according to claim 14, wherein the first duty cycle is 50% and the third duty cycle is 100%.

16. A method of a controlling a fixing temperature of a fixing device of an image forming apparatus, comprising:
determining a mode of operation of the image forming apparatus;
detecting the fixing temperature; and
controlling a heating element of the fixing device to be switched on and off based on the mode of operation of the image forming apparatus and the detected fixing temperature.

17. The method according to claim 16, wherein
the heating element is controlled to be switched on and off based only on the detected fixing temperature relative to a target temperature.

18. The method according to claim 16, wherein
the heating element is controlled to be switched on and off based on the detected fixing temperature relative to a target temperature, a reference temperature that is below the target temperature, and whether or not the detected fixing temperature is increasing or decreasing.

19. The method according to claim 18, wherein
according to the second duty control, the heating element is controlled to be on with a first duty cycle when the detected fixing temperature is less than the target temperature and greater than the reference temperature, a second duty cycle greater than the first duty cycle when the detected fixing temperature is less than the reference temperature and the detected fixing temperature is increasing, and a third duty cycle greater than the second duty cycle when the detected fixing temperature is less than the reference temperature and the detected fixing temperature is decreasing.

20. The method according to claim 19, wherein the first duty cycle is 50% and the third duty cycle is 100%.
